(19) United States
(12) Patent Application Publication
(10) Pub. No.: US 2018/0140001 A1
(43) Pub. Date: May 24, 2018

(54) NICOTINE SOLUTIONS, DELIVERY SYSTEMS AND PROCESSES

(71) Applicant: EYAL GABBAY, Dallas, TX (US)

(72) Inventor: EYAL GABBAY, Dallas, TX (US)

(21) Appl. No.: 15/624,107

(22) Filed: Jun. 15, 2017

Related U.S. Application Data
(60) Provisional application No. 62/426,174, filed on Nov. 23, 2016.

(51) Int. Cl. A24B 15/16; G09B 21/00

(52) U.S. Cl. CPC A24B 15/167; G09B 21/00

(57) ABSTRACT

Nicotine-containing solutions, kits, nomograms, delivery systems and processes for making and delivering a great number of nicotine-containing solutions of difference nicotine strengths with a minimum of containers of starting ingredients, using one of a selection of nicotine base containers having numerous concentrations of nicotine with one of a plurality of pg or vg containing solutions in predesignated volumes to create end result, nicotine-containing vaporizable solutions, and including computer implemented processes for converting e-juices and drip juices used for vaporizers, electronic cigarettes, e-cigs, e-cigars, e-pipes and the like into e-juices and drip juices containing particular concentrations or strengths of nicotine for delivery to and use by end users.

### CROSS-REFERENCE TO RELATED APPLICATION

This application claims the benefit of and priority from U.S. provisional application No. 62/426,174 filed on Nov. 23, 2016 and entitled NICOTINE SOLUTIONS, DELIVERY SYSTEMS AND PROCESSES. The contents of the above application are hereby incorporated herein by reference in full.

### FIELD OF INVENTION

The invention relates generally to solutions such as nicotine-containing solutions, delivery systems and processes for making and delivering nicotine (or other solute)-containing solutions. More specifically, it relates to systems and processes for converting non nicotine containing e-juices, Cannabidiol (CBD) e-juice and drip juices used for vaporizers, electronic cigarettes, e-cigs, e-cigars, e-pipes and the like into e-juices and drip juices containing a particular concentration of nicotine, and for converting nicotine containing e-juices, CBD e-juices and drip juices into such juices having higher concentrations of nicotine.

### BACKGROUND

An electronic cigarette and related devices, typically referred to as an e-cigarette, an e-cig EC, an electronic nicotine delivery system (ENDS), an electronic non-nicotine delivery system (ENNDS) or a personal vaporizer (PV) are handheld electronic devices that vaporize a selected flavored liquid from a wide variety of available flavored liquids. These devices are typically handheld, are often made to appear like conventional cigarettes and are used in much the same way. The modern e-cigarette was invented in 2003 and since then use of e-cigarettes and related products has risen exponentially. The user of an e-cigarette or a related device typically inhales the vapor. Use of these devices is typically referred to as vaping.

E-cigarettes are available in various designs, voltages and sizes, such as cigalikes, that look like cigarettes; eGos, that are bigger than cigalikes and can have refillable liquid tanks; e-cigars that are analogous to cigars; e-pipes that are analogous to pipes; and mods, which assemblies are made from basic parts or made by altering existing products and are then used for vaping. These devices can also include variable voltage capability and temperature control. A typical power source is a rechargeable lithium-ion battery.

The flavored liquids are generally referred to as e-liquid(s), e-juice(s) or juice(s). These liquids are placed inside the e-cigarette and are heated sufficiently to produce an aerosol or vapor. In general, these liquids include propylene glycol (pg), glycerin, water, nicotine and flavorings. Typical, conventional e-liquids contain propylene glycol and glycerin, and are available in more than 8,000 flavors.

The main components of a typical e-cigarette include a mouthpiece, a cartridge or tank, a heating element or atomizer, a microprocessor, a battery and, optionally, an LED light at one end. In a mechanical e-cigarette the electrical circuit is closed by a mechanical switch. The atomizer includes a heating element or coil that vaporizes the e-liquid and a wick that draws e-liquid onto the coil. In some designs the e-juice is dripped directly on the atomizer, and when used in these designs the e-juice is typically referred to as drip-juice or drip juice. Additional information about e-cigarettes and related vaping devices is found at https://en.wikipedia.org/wiki/Electronic cigarette/ [downloaded Nov. 10, 2016], the entirety of which is incorporated by reference, and at http://vaporcloudreviews.com/beginners-guide-to-dripping/[downloaded Nov. 10, 2016], the entirety of which is incorporated by reference.

Non-nicotine or zero nicotine containing solutions are often offered by vape shops and other suppliers alongside nicotine containing E-juice and drip-juice solutions. Systems and processes for adding nicotine to nicotine containing e-juices, CBD e-juice and drip juices, as well as to non-nicotine containing e-juices, CBD e-juice and drip juices used for vaporizers, electronic cigarettes, e-cigs, e-cigars, e-pipes and the like into e-juices and drip juices containing a particular concentration of nicotine that is higher than the prior nicotine concentration are described herein. The invention also relates to bottles, in particular, single-use bottles with a child resistant cap that can be used with the delivery systems and processes described herein. Suppliers, such as retail stores (often referred to as vape shops) that sell vaporizers, electronic cigarettes, e-cigs, e-cigars and/or e-pipes and the like often mix e-juice or drip juice containing nicotine and/or flavors for customers or users to purchase, and often carry in inventory a number of bottles containing a selection of e-juices with various concentrations of nicotine and with various flavors for each concentration of nicotine. E-juices and drip juices are typically sold in small bottles that contain pre-mixed solutions comprising nicotine as the principal solute, in various concentrations in a carrier liquid, or solvent that is typically propylene glycol or other similar synthetic organic compounds and/or vegetable glycerin or similar liquids produced from plant oils, typically palm oil, soy, or coconut oil, or oils. The solution may include flavoring or be without flavoring. Some suppliers offer non-nicotine or zero nicotine-containing solutions alongside nicotine-containing solutions, where the nicotine containing solution is provided in relatively large bottle, such as 250 ml, and the nicotine-containing solution is referred to as the “base”. These systems have been referred to as “drip” or “dripping” systems, because a pipette or dropper is used to extract base solution from the relatively large container and then is used to “drip” a predetermined number of drops or volume of the base into a non-nicotine-containing solution. Some suppliers also offer small bottles or tubes of “base,” that is, tubes containing a single, known volume of liquid and one or two known amounts of nicotine, such as 1 ml tubes containing 10% nicotine and 1 ml tubes containing 20% nicotine. With these products a user decides the concentration or amount of nicotine desired in a final solution containing nicotine, and then “drips” or empties the required number of tubes of nicotine-containing base to a non-nicotine-containing solution to yield a nicotine containing e-juice with the desired amount or concentration of nicotine. None of these dripping systems provide numerous, different concentrations of nicotine base solutes in relatively small, predetermined volumes, such that a relatively great number of choices of final nicotine amounts, strengths or concentrations can be made with a minimum numbers of bottles/tubes of base nicotine-containing liquid, and without need for a dropper or pipette to measure out and add specific volumes of base to a non-nicotine containing solution to achieve a specific, desired nicotine amount or concentration in a final vaporizable e-juice.

Given the numerous concentrations of nicotine in e-juice and drip juice solutions, the wide variety of e-juice and drip juice flavors, and the numerous combinations and variations of such concentrations and flavors, an e-juice and drip juice supplier would have to carry a huge inventory of pre-mixed solutions to supply all of these combinations. For example, a typical supplier, such as a retail store typically would have 50 flavors of e-juice with 4 different concentrations of nicotine per flavor. Such a store that carries an inventory of 12 bottles of e-juice per flavor per nicotine concentration would have a total of 2,400 bottles in inventory. And if that store carried 9 different concentrations of nicotine per flavor, it would have 5,400 bottles in inventory.

Currently there is no known effective and/or efficient way of reducing inventory of final vaporizable, nicotine-containing e-juice, of containers of base and at the same time providing e-juice or drip juice base containers having multiple concentrations of nicotine and multiple variations of flavors. Currently there is also no known effective and/or efficient system or process for a customer, user or supplier to mix one of many, specific amounts or concentrations of nicotine-containing base liquid with non-nicotine-containing e-juice or drip juice (flavored or non-flavored) to yield solutions containing the desired amount(s) or concentration(s) of nicotine. There is also no known nicotine delivery system in which nicotine-containing liquid solutes, or bases, having numerous, different predetermined amounts or concentrations of nicotine are available in pre-filled containers and adapted for mixing with non-nicotine containing solvents in pre-filled containers to yield desired concentrations of nicotine e-juices and/or drip juices. Thus, it is desirable to have solutions, systems and processes that enable an e-juice and/or drip juice supplier to carry in inventory sets of bottles of solutions containing predetermined volumes of solutions containing nicotine at various, predetermined concentrations and sets of bottles of solutions containing various, predetermined volumes of non-nicotine containing solvents also having various flavorings, such that mixing the contents of a selected nicotine-containing bottle with the contents of a non-nicotine containing bottle yields a solution that contains a desired concentration of nicotine and a desired flavoring. As will become apparent, the present disclosure provide solutions, systems, kits and processes by which numerous e-juices and drip juices having a wide range of nicotine concentrations and varieties of flavorings are available to a supplier and/or a user, while at the same time reducing inventory required to be maintained by the supplier. In other words, the present systems, kits and processes maximize the number of different concentrations of nicotine-containing vaporizable solutions medically approved for use and minimize the number of containers of constituent materials needed. The solutions, systems and processes as presently disclosed also provide customers and users with the ability to purchase and mix specific amounts of nicotine-containing liquid with non-nicotine-containing liquid with ease, to make e-juice(s) and/or drip juices(s) containing the desired amount(s) or concentration(s) of nicotine and if desired, with flavoring. The presently disclosed systems, kits and processes also provide for minimization of and/or avoidance from accidental exposure to large amounts of nicotine, which is toxic. The presently disclosed systems, kits and processes also provide for the ability to add and/or increase the nicotine levels, from zero, or from a lower concentration of nicotine to a higher concentration of nicotine, in the solutions.

Moreover, a significant problem with previous bottles for dispensing liquid is that they are bulky, cumbersome, contain many parts, are not easily carried in a handbag or pocket, and are expensive to make. Additionally, many existing designs have been suggested for safety caps for bottles containing medicine and the like, or other substances which may be harmful to small children. Such caps must be readily operable by adults or older children but must embody means to prevent or resist their being opened by small children. Some of these caps have been very complex involving combination type locks; others have been equipped with bayonet-type locking means requiring depression of the cap or a portion thereof followed by rotation to disengage the bayonet-type lugs and permit removal of the cap. Additionally, existing bottles are generally designed for multiple applications or reuse which increases the potential for contamination and/or usage that deviates from recommended or specified usage of the liquid contained in the bottle. Unlike the previous devices the present invention is a single-use bottle designed for easy handling during application, easy twist-off/no tool opening, easy to dispense liquids from, has a tamper-evident and child-resistant screw cap that is simple, easy to use, and re-closeable.

### SUMMARY

This summary is provided to introduce a selection of inventive features in a simplified form that are further described below in the detailed description. This summary is not intended to identify only key features or only essential features of the claimed subject matter, nor is it intended to be used in isolation as the sole aid in determining the scope of the claimed subject matter.

The invention relates generally to nicotine-containing solutions, delivery systems, kits and processes for making and delivering nicotine-containing solutions and more specifically to systems and processes for converting nicotine-free e-juices and drip juices used for vaporizers, electronic cigarettes, e-cigs, e-cigars, e-pipes and the like into nicotine-containing e-juices and drip juices for delivery to end users, or to convert nicotine containing e-juice and/or drip juice, to a higher concentration of nicotine. Solutes other than nicotine (such as flavored solutions) may be utilized in the present invention. The nicotine used may be natural or synthetic and/or a salt of nicotine from a natural or synthetic source.

The nicotine-containing liquid, also referred to as nicotine base, base, nicotine base solute is typically contained in small pre-filled tubes, or bottles (such as single-use, tamper-resistant/child-proof bottles), in small volumes, such as 1 milliliter or 2 milliliters and at various concentrations of nicotine. The solvent of the nicotine-containing base solution is typically propylene glycol (pg) or vegetable glycerin (vg). The nicotine-containing base solution is added into another, larger bottle containing a specified amount of e-juice or drip juice, and the combined liquids are then mixed, preferably by shaking. The volume of e-juice or drip juice added depends on the desired concentration of nicotine in the resulting, vaporizable solution.

A significant problem with conventional pre-filled bottles for dispensing liquids is that they are bulky, cumbersome, contain many parts, are not easily carried in a handbag or pocket, and are expensive to make. Many designs for safety caps for bottles containing medicine and the like, or other substances which may be harmful to small children are known. Such caps must be readily operable by adults or older children but must embody means to prevent or resist being opened by small children. Some of these known caps are very complex, involving combination type locks; others are equipped with bayonet-type locking means requiring depression of the cap or a portion thereof followed by rotation to disengage bayonet-type lugs and to permit removal of the cap. Additionally, existing bottles are generally designed for multiple applications or reuse which increases the potential for contamination and/or usage that deviates from recommended or specified usage of the liquid contained in the bottle. Unlike conventional bottles used in the field of nicotine containing solutions for vaping, the present invention also preferably includes a single-use bottle designed for easy handling during application, having an easy twist-off/no tool opening that is easy to dispense liquids from, has a tamper-proof and child-resistant screw cap that is simple, easy to use, and re-closeable.

These and other aspects, embodiments, features, and advantages of the invention will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a nomogram or table listing exemplary containers having various predetermined capacities and containing various predetermined concentrations of nicotine solute solutions, and exemplary containers having various predetermined capacities and containing predetermined volumes of non-nicotine solvents in accordance with aspects of the present invention;

FIG. 2 is a schematic depicting exemplary steps for preparing nicotine-containing solutions using the FIG. 1 nomogram in accordance with aspects of the present invention;

FIG. 3 is a top perspective view depicting an exemplary bottle with a cap, in accordance with aspects of the present invention;

FIG. 4 is a top perspective view of the exemplary bottle shown in FIG. 3, with a cross-sectional view of the cap;

FIG. 5 is a top perspective view of the exemplary bottle shown in FIG. 3, with a cross-sectional view of the cap, showing the direction in which the cap is pressed to open and close the cap;

FIG. 6 is an exploded view of the exemplary bottle shown in FIG. 5, showing a perspective view of the bottle neck with external threads, the cap and the cap inner shell;

FIG. 7 is an exploded view of the exemplary bottle shown in FIG. 5, showing a perspective view of cap shell inner threads and a cutaway view of the cap inner shell;

FIG. 8 is an exploded cross-sectional view of the exemplary bottle shown in FIG. 5, showing a cross-sectional view of the bottle body, bottle neck, cap and its inner shell;

FIG. 9 is an exploded cross-sectional view of the exemplary bottle shown in FIG. 5, showing a cross-sectional view of the bottle body, bottle neck, cap and cap inner shell partially inserted into the cap;

FIG. 10 is a cross-sectional view of the exemplary bottle shown in FIG. 5, showing the direction in which the cap engages with the bottle neck;

FIG. 11 is a cross-sectional view of the exemplary bottle shown in FIG. 5, showing the cap engaging the bottle neck, and closing the bottle by pressing down on the cap and rotating it clockwise;

FIG. 12 is a cross-sectional view of the exemplary bottle shown in FIG. 5, showing the cap engaged with the bottle neck;

FIG. 13 is a cross-sectional view of the exemplary bottle shown in FIG. 5, showing the cap engaging the bottle neck, and how the bottle cap is removed by pressing down on the cap and rotating it counter-clockwise;

FIG. 14 is a cross-sectional view of the exemplary bottle shown in FIG. 5, showing the distal end of cap with a cavity that includes a sharp, pointed puncture tool or pin that extends from the center and that has an inner diameter such that it fits over the tip of the bottle, with the pin puncturing a thin layer of plastic that seals the opening of the tip of the bottle;

FIG. 15 is a cross-sectional view of the exemplary bottle shown in FIG. 5, with the cap engaged with the bottle neck in a closed position;

FIG. 16 is a perspective view of the exemplary bottle shown in FIG. 5, showing a user's hands handling the bottle by holding the tab while touching the cap;

FIG. 17 is screen-shot view of an exemplary display for an online calculator for use with standard sized nicotine containing solute containers and standard sized vaporizable solvent-containing solvent containers; and,

FIG. 18 is a screen-shot view of an exemplary display for an on-line calculator for use with non-standard, custom or odd sized nicotine-containing solute containers and non-standard, custom or odd sized vaporizable solvent-containing solvent containers.

Reference symbols or names are used in the figures to indicate certain components, aspects or features shown therein. Reference symbols common to more than one figure indicate like components, aspects or features shown therein.

### DETAILED DESCRIPTION

The subject matter of aspects of embodiments of the presently described systems and processes is described herein with reference to the figures and the published information incorporated by reference. However, the description itself is not intended to limit the scope of any patent issuing from this description. Rather, the inventor has contemplated that the claimed subject matter might also be embodied in other ways, to include different elements or combinations of elements similar to the ones described herein, in conjunction with other present or future technologies.

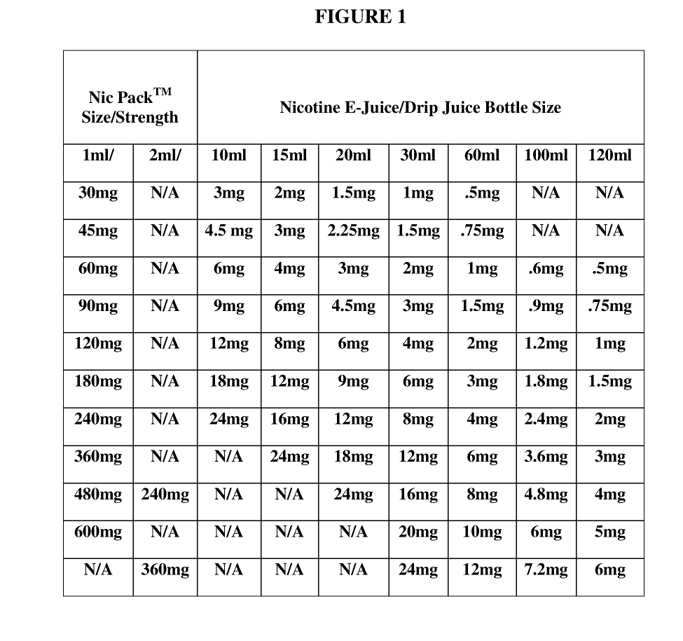

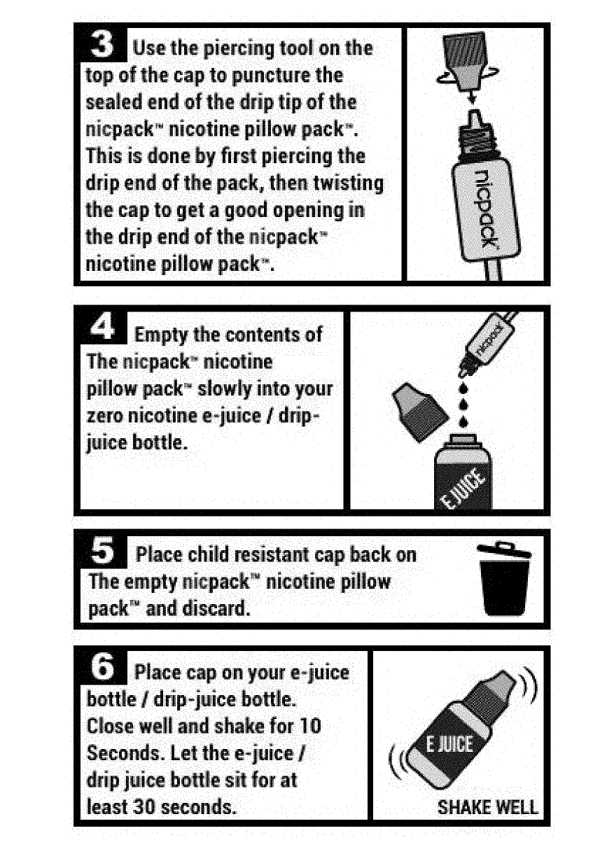

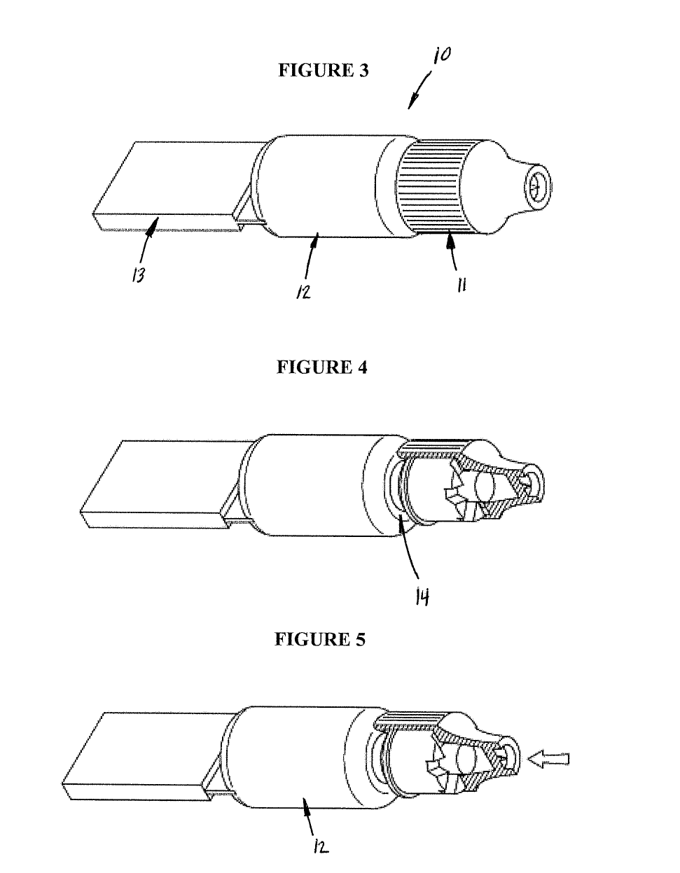

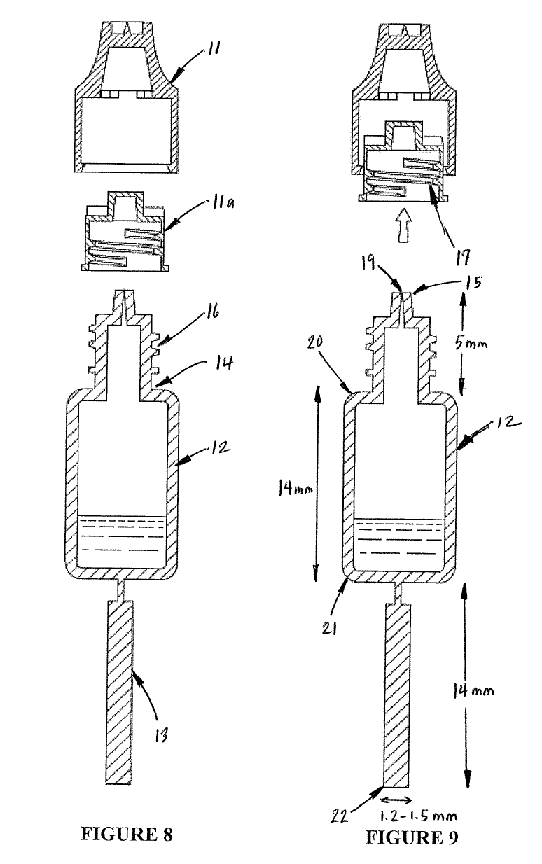

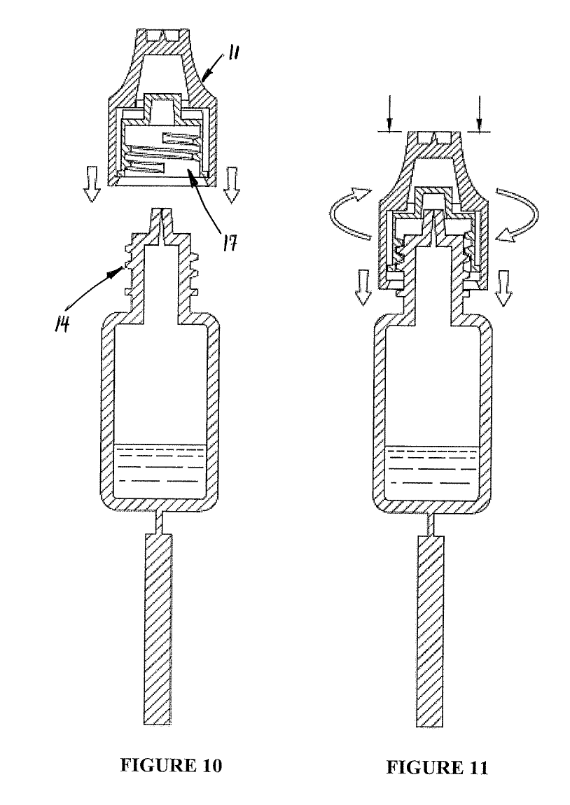

With reference to the drawings, and in particular to FIG. 1, preferred embodiments will be described. FIG. 1 is a nomogram/table for preferred, exemplary (i) various, selections of predetermined amounts/concentrations of nicotine base in small volume, sealed containers (columns 1 and 2, rows 2-13); (ii) a selection of bottles of predetermined volume capacity for containing zero nicotine, or relatively low amounts/concentrations of e-juice or drip juice (columns 3-9, row 2) solutions; and (iii) cells listing the desired, or end result amounts/concentrations of nicotine in a final, nicotine-containing vaporizable solution, with each cell at the intersection of corresponding column/row(s) of nicotine base and e-juice/drip juice. The FIG. 1 nomogram includes two sections: with the first section including the top row (Row 1) and 2 title columns (Title Column 1 and Title Column 2); and with the second section including 12 rows (Rows 2-13) and 9 columns (Columns 1-9). Row 2, Columns 1 and 2 list various, different, relatively high concentrations of nicotine base solute in 1 ml and 2 ml bottles, respectively. Each of these relatively highly concentrated solutions in one of the 1 ml or 2 ml bottles or containers may also be referred to as a “base”, “nicotine base”, “solute”, a “nicotine solute, a “Nic pack” or a “nicotine pillow pack”. The amount of the nicotine may also be referred to as “strength”. While the nicotine-containing liquid is preferably placed in small bottles or other containers such as sealed plastic tubes, pre-filled to volumes of 1 milliliter or 2 milliliter, it can be placed in bottles, tubes or other containers of other sizes, so long as it functions for the intended purpose of the systems and processes described herein. The preferred bottle or container is tamper-resistant and child-proof, and is preferably made of LDPE (low-density polyethylene). The bottle or other container is preferably for single-use only and can also be made of glass, metal, various types of plastic or other materials. An exemplary bottle that may be used in the present process or system is depicted in FIGS. 3 through 16 and is described in detail below.

Referring to FIG. 1, Column 1, Rows 2-13, the nicotine in each “Nic pack” preferably is provided in individual, single-use bottles or other containers, in amounts such as, but not limited to, 30 milligram (mg), 45 mg, 60 mg, 90 mg, 120 mg, 180 mg, 240 mg, 360 mg, 480 mg and 600 mg, in a total volume of 1 ml of nicotine plus base to provide concentrations of [30 mg/ml]; [45 mg/ml]; [60 mg/ml], etc., for the 1 ml bottle. The amounts/concentrations may also include 270 mg, 540 mg and 720 mg, and other amounts, as will be appreciated by those skilled in this field. Regarding the exemplary 2 ml bottles, Column 2, Rows 2-13, the nicotine concentrations would be [60 mg/2 ml]=[30 mg/ml]; [90 mg/2 ml]=[45 mg/ml]; [120 mg/2 ml]=60 mg/ml], etc., for the bottles filled with the stated amounts of nicotine base to a total volume of 2 ml.

WARNING: Various cells in the FIG. 1 table/nomogram Rows 3-4 and 10-13 have the entry “N/A”. The reason for the “N/A” designation in those rows is that the amounts that would be listed in the respective cells are NOT RECOMMENDED because they are believed to be too high to be medically safe. Should these higher amounts or concentrations be deemed to be medically safe, one of ordinary skill in this field can determine the concentration(s) of nicotine for a given amount of nicotine in a given volume of liquid. Also, many of rows in Column 2 are designated as “N/A”, for the same reason and/or for the reason that the 1 ml bottle is preferred because it can be used with small concentrations as well as larger concentrations of end product as listed in Columns 3-9, and therefore serves to reduce the total number of differently sized nicotine containing base containers than would be included in inventory if a complete set of 2 ml bottles corresponding to the rows in Column 2 were kept in inventory. Other variations in bottle/container size, volume, nicotine amounts, total volume, types of liquid base and nicotine concentrations may be used. Also, multiple bottles of Nic pack may be used to yield a higher concentration of nicotine, with the WARNING, as above, that only concentrations designated as medically safe should be prepared, and that higher concentrations than those that are deemed medically safe should be strictly avoided. The base or solvent used for the nicotine solute preferably comprises vegetable glycerin (vg) and/or propylene glycol (pg), or other liquids with similar properties, as are well known to those skilled in this field.

In an exemplary embodiment, the single-use bottles/containers/tubes may be part of a solution preparation kit that comprises a single-use bottle (referred to as a “first container”, “first bottle” or a “first tube”) containing a particular concentration of nicotine base and one or more “second container(s)” containing a vaporizable solvent that contains either no nicotine or some known concentration of nicotine. There may also be one or more “third container(s)” adapted for mixing the contents of a first container with the contents of one of the second containers.

Again referring to FIG. 1, Row 2, Columns 3-9 refer to and list seven exemplary second bottle/container sizes, with the bottles/containers larger than the first bottles/containers listed in Columns 1 and 2. The bottles/containers listed in Row 2, Columns 3-9 have been pre-filled with a desired vaporizable solvent, to a predetermined volume, such that when the contents of the Row 2, Column 1 or 2, first nicotine-containing bottle/container are mixed with the vaporizable solvent in a second bottle/container, such as listed in any of Row 2, Columns 3-9, the concentration of the nicotine in the final solution is listed in the corresponding cell. For example, when the contents of the Column 1, Row 3 Nic pack, i.e., 30 mg in a 1 ml bottle are mixed with, or diluted by mixing with the predetermined volume of vaporizable solvent in the Column 3, Row 3, 10 ml bottle, the resulting concentration of nicotine is [30 mg/10 ml]=[3 mg/ml] and the “strength” of the nicotine is 3 mg. In this example, the 10 ml bottle has been pre-filled with a predetermined amount of solvent, such that when the contents of the Column 1, Row 1 Nic pack (1 ml) has been added to the Column 3, Row 3 bottle, the total volume in the 10 ml bottle is 10 ml. Similarly, the Columns 3-9 bottles have been pre-filled with a volume of solvent that is less than the capacity of the bottle, and depending on whether the Nic pack is a 1 ml or 2 ml bottle.

During the process of mixing the contents of a chosen Nic Pack™ first container with a chosen volume of vaporizable solvent in the second container, the specified volume of nicotine-containing liquid base is added to e-juice or drip juice contained in one of the bottles listed in Columns 3-9 of the FIG. 1 table. As shown, these preferred, exemplary solvent bottles hold volumes of up to 10 ml, 15 ml, 20 ml, 30 ml, 60 ml, 100 ml, or 120 ml, respectively, and are pre-filled as described above. Any solvent bottle or other container may be used, such as those that are known in the art. Other bottle sizes, volumes and pre-fill volumes of solvent may be used to provide e-juice or drip juice of desired concentrations. The vaporizable solvents used to make e-juice and drip juice in accordance with the presently disclosed processes preferably are conventional propylene glycol (pg) or other similar synthetic organic compounds, vegetable glycerin (vg) or similar liquids produced from plant oils, typically palm oil, soy, or coconut oil, or oils that nicotine or flavored liquids may be mixed into. The solvents used to make e-juice or drip juice may be flavored, such as by adding food flavorings to create a particular taste. The nicotine delivery systems, as exemplified by the FIG. 1 nomogram and process described above using the Nic pack or nicotine pillow pack bottles shown in FIG. 1, in combination with the solvents in bottle sizes of 10 ml, 15 ml, 20 ml, 30 ml 60 ml, 100 ml, and 120 ml will yield many concentrations of nicotine per Nic pack bottle size, while greatly reducing the number of bottles that the supplier must keep in inventory, as compared to the conventional nicotine solution delivery systems. Use of the present system and process is also advantageous because they eliminate the problems of inaccurate mixing and spillage associated with conventional “drip” systems. As shown in FIG. 1, a set of 1 ml and 2 ml Nic pack bottles, each of the bottle sizes having 11 nicotine concentrations will yield a total of at least 64 different concentrations of nicotine in the e-juice or drip juices that can be prepared by the present exemplary system and process. Final or desired nicotine concentrations are not limited to just those shown in FIG. 1 because the solvent (or e-juice or drip juice) may already contain nicotine and such nicotine-containing solvents may be mixed with various Nic packs containing different amounts of nicotine. For example, 45 ml of solvent or e-juice or drip juice that already has 3 mg of nicotine, when mixed with a 1 ml Nic pack containing 90 mg of nicotine, will yield a final nicotine concentration of 138 mg/ml.

The presently described nicotine-containing solutions, kits, delivery systems and processes for making and delivering nicotine-containing solutions specifically relate to systems and processes for converting nicotine-free, vaporizable e-juices and drip juices used for vaporizers, electronic cigarettes, e-cigs, e-cigars, e-pipes and the like into nicotine-containing e-juices and drip juices for delivery to end users, or to convert nicotine containing e-juice and/or drip juice, to a higher concentration of nicotine. Thus, the systems relate to adding nicotine to non-nicotine e-juice and/or drip juice, and/or raising the concentration of nicotine in nicotine-containing e-juice and/or drip juice, to achieve a particular concentration or strength of nicotine to be used by an end user. The nicotine used may be natural or synthetic and/or a salt of nicotine derived from a natural or synthetic source. The following algorithm or formula may be applied by various ways, such as through a web-based, online computer implemented process to obtain the desired concentration of nicotine:

$$[ \frac{\begin{matrix}[ ( mg of nicotine in solvent ) \times ( ml of solvent ) ] + \\ [ ( mg of nicotine in solute ) \times ( ml of solute ) ]\end{matrix}}{[ \begin{matrix}Total ml of nicotine solvent + \\ total ml of vaporizable solute\end{matrix} ]} ] = [ \begin{matrix}final concentration \\ of mixed nicotine \\ solute and\end{matrix} ]$$

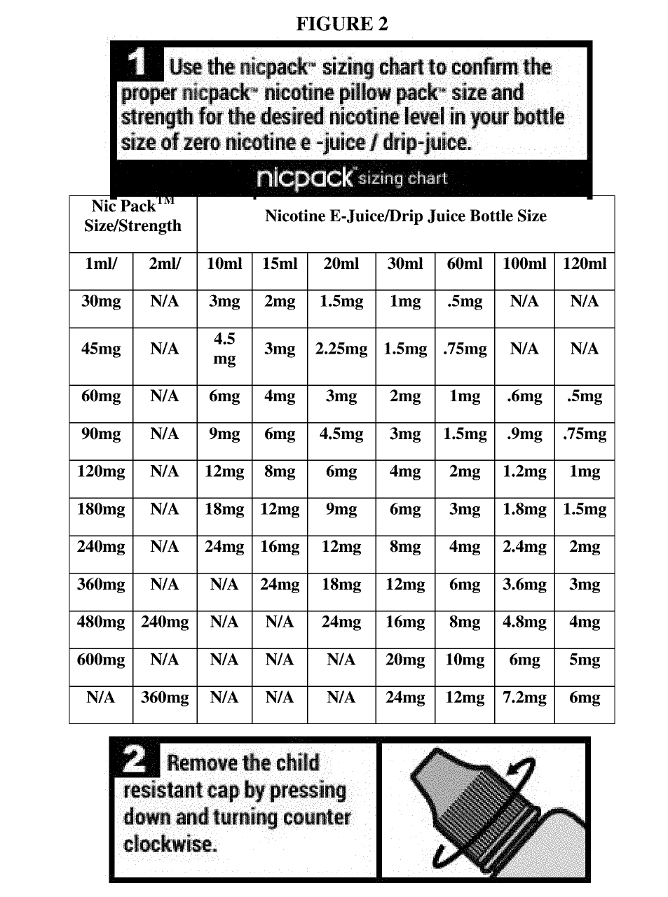

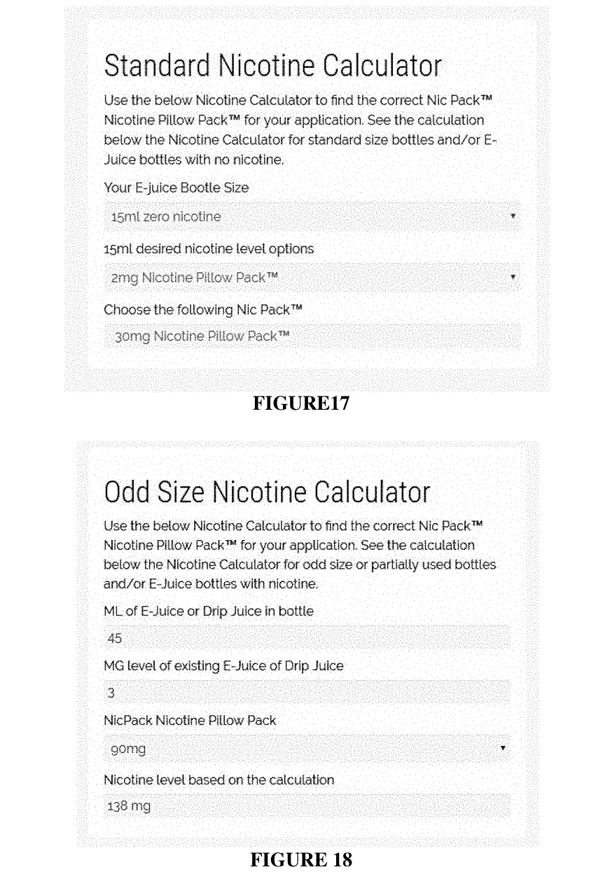

With reference to FIGS. 17 and 18, exemplary embodiments of computer-implemented processes incorporating the above formula (such as in the form of an online calculator) can be used by an end user or by a supplier, such as a retail store, in determining the appropriate container of nicotine-containing liquid solute (or Nic pack) to use with a given e-juice bottle size containing a predetermined volume of vaporizable solution in order to yield a desired concentration of nicotine. FIG. 17 illustrates a preferred user interface for standard container sizes, such as shown in FIG. 1. FIG. 18 illustrates a preferred user interface for non-standard container sizes and non-standard concentrations of ingredients. The preferred calculator uses a conventional “Calculated Fields Form” application available on the Internet, at http://cff.dwbooster.com (as downloaded on May 12, 2017). Creation of a specific form, with using the formula/algorithm as set forth herein, and the dwbooster application is within the skill of those of ordinary skill in this field. Through use of such computer implemented processes, the system or kit is not limited to only standard container sizes, such as shown in FIGS. 1-2, but rather may be used for other, non-standard, custom container sizes, nicotine amounts and volumes of vaporizable solutions. As such the computer implemented process enables a physical transformation of a relatively high nicotine concentration solute and one relatively low nicotine concentration of vaporizable solvent or nicotine free vaporizable solvent to be transformed into a nicotine containing, vaporizable solution that has a desired nicotine concentration or nicotine strength. For example, a user (or supplier) may enter or select from a drop-down menu provided on an online display, the e-juice (or solvent) bottle size (such as 10 ml, 15 ml, 20 ml, 30 ml, 60 ml, 100 ml, 120 ml bottle or other sized bottle or container) and enter or select from another drop-down menu on the display, the desired final nicotine concentration or strength. The computer implemented process would then calculate and display the appropriate Nic pack size (such as 30 mg, 45 mg, 60 mg, 90 mg, 120 mg, 180 mg, 240 mg, 360 mg, 480 mg, 600 mg) to yield such desired concentration/strength of nicotine. The computer implemented process uses an algorithm or formula, such as described above, and in accordance with well-known computer code and code writing techniques and procedures, such as provided at http://cff.dwbooster.com.

Referring to FIG. 17, a screen shot view of an exemplary embodiment of the above-described computer-implemented process for an online calculator is shown. The online calculator is for use with standard sized nicotine containing solute containers and with standard sized vaporizable solvent containing solvent containers. For example, a user (or supplier) enters or selects from a drop-down menu provided on an online display a 15 ml e-juice bottle size. The user (or supplier) then selects from one of the desired nicotine level options, such as 2 mg. The calculator then displays the appropriate Nic pack size to use, which, as shown in FIG. 17, would be 30 mg.

Referring to FIG. 18, a screen shot display, another exemplary embodiment of the above-described computer-implemented process is shown. The FIG. 18 embodiment is for an online calculator for use with non-standard, custom or odd sized nicotine containing solute containers and non-standard, custom or odd sized vaporizable solvent containing solvent containers. For example, a user (or supplier) who has 45 ml of solvent or e-juice or drip juice that already contains 3 mg of nicotine, and mixes it with a 1 ml Nic pack containing 90 mg of nicotine, will have a resulting solution having a final nicotine concentration of 138 mg/ml.

The above bottle sizes and concentrations are merely exemplary, and as will be understood by those skilled in this art, the user may increase the nicotine concentration of an existing e-juice that has zero or a particular concentration of nicotine, using an online, computer-implemented calculator that incorporates or utilizes the above formula.

A stock keeping unit (SKU) system also may be used to track the inventory of pre-filled “Nic packs” and pre-filled solvent bottles in which the final e-juice and/or drip juice-filled bottles are produced. As is well known, a SKU is a product and service identification code for a supplier, such as a store, placed on a product, and typically used in a machine-readable bar code. Typically, if a store wanted to carry a conventional e-juice selection with 50 flavors at 6 different concentrations of nicotine, then 300 SKUs would be needed. The present system, however, enables an e-juice selection including 50 flavors at 6 different concentrations of nicotine with only 56 SKUs.

Referring now to FIG. 2, preferred, exemplary steps for preparing nicotine-containing solutions having desired concentrations or strengths of nicotine in the final vaporizable solution for use by the end user in accordance with aspects of the present systems and kits will be described.

First, a person or user (such as a customer, sales agent or end user intending to buy and/or use a nicotine-containing solution in a vaporizer, electronic cigarettes, e-cigs, e-cigars and/or e-pipes, etc.) refers to a sizing chart, such as FIG. 1 nomogram, to choose a first bottle or container, referred to as a nicotine solute or “Nic pack” and having a first size (such as 1 ml or 2 ml) and first bottle nicotine concentration to result in or yield a desired nicotine concentration in the resulting nicotine containing e-juice or drip juice, and then choosing the correspondingly sized bottle or container (such as 10 ml, 15 ml, 20 ml, 30 ml, 60 ml, 100 ml or 120 ml bottle) containing the pre-filled vaporizable solvent in the predetermined amount or volume. For example, a 1 ml volume (or “size”) bottle of “Nic pack” or “nicotine pillow pack” containing 120 mg of nicotine would have a concentration of nicotine of [120 mg/ml]. When combined or mixed with the contents of a 20 ml sized bottle having been pre-filled with a predetermined volume of zero nicotine-containing, vaporizable solvent, will result in a bottle of e-juice having a nicotine concentration of [6 mg/ml]. In other words, the end-user chooses the final concentration or strength of nicotine to be used for the vaping session, then refers to the nomogram to pick (i) the corresponding solvent bottle size that is pre-filled with the corresponding, predetermined volume of solvent and (ii) the solute bottle size having the predetermined nicotine solute concentration that, upon mixing the contents of the two bottles will yield or result in the chosen final nicotine concentration or strength.

As another example, a 2 ml volume (or “size”) “Nic pack” with 120 mg of nicotine, when combined with a 20 ml bottle pre-filled with the appropriate amount of vaporizable solvent, will result in a bottle of e-juice having a 12 mg of nicotine and a nicotine concentration of [12 mg/20 ml]=[6 mg/ml]. As yet another example, a 1 ml “Nic pack” with 45 mg of nicotine, when combined with a 60 ml bottle containing 59 ml of solvent, will result in an e-juice having a nicotine concentration of [0.75 mg/ml].

Second, the user then removes the cap of the “Nic pack” bottle or otherwise opens the bottle or container, such as by cutting off the top of the container or tube, in the event the container is, for example, sealed container or tube. The bottle preferably has a child-resistant cap, such that the user would have to press the cap down and turn counter-clockwise (or clockwise) to remove the cap.

Third, the user then would use the piercing tool found on the back of the child-resistant cap to puncture the sealed end of the drip tip of the “Nic pack” bottle. This structure provides for additional tamper-resistance and is an additional child-proofing feature that functions to prevent access to and exposure to the nicotine by children.

Fourth, the user empties the contents of the nicotine solute container, or “Nic pack” bottle slowly into the chosen bottle having pre-filled vaporizable solvent.

Fifth, the user replaces the child-resistant cap back on the “Nic pack” and discards the bottle.

Sixth, the user places the cap of the e-juice or drip juice bottle back on the bottle and shakes the bottle.

Seventh, the user lets the resulting nicotine-containing solution sit for a few seconds to yield the final e-juice or drip juice product.

Eighth, the resulting e-juice or drip juice, having the desired concentration nicotine, is now ready for use in vaporizers, electronic cigarettes, e-cigs, e-cigars, e-pipes and the like.

With reference again to the drawings, and in particular to FIGS. 3, 4, 5, 6 and 7, a preferred exemplary bottle 10 is described. Bottle 10 is generally comprised of a body 12 having a longitudinal centerline, a neck 14 extending from a first end of the body 12 and a tab 13 extending from the opposite, second end of the body. Tip 15 is preferably unitary with neck 14 and extends outward from neck 14. Tip 15 includes a channel having a sealed or closed end adapted for puncturing to provide an opening shown at 19, positioned at the distal end of the tip 15. Body 12 is preferably cylindrical, with a predetermined inner radius and predetermined outer radius extending outward from the longitudinal centerline. Body 12 also includes exterior threaded neck 14, and an unthreaded outlet, nozzle or tip 15 that extends outward from neck 14 and that, upon puncturing, has an opening 19 through which liquid is dispensed. Tip 15 and neck 14 each are preferably cylindrical in shape and each has a predetermined length and a predetermined radius, with the outer radius of neck 14 that is smaller than the outer radius of body 12 and the outer radius of tip 15 smaller than the outer radius of neck 14. Flexible tab 13 extends from the distal end of the body 14 and functions to facility easy handling and use of the bottle.

The preferred bottle 10 can vary in size and geometric shape, can be a different type of container such as a tube, and can be formed from a variety of materials such as, for example, soft or hard plastic, e.g., polypropylene, low density polyethylene, high density polyethylene, or other manually deformable material. The bottle 10 can be produced in one or two pieces by conventional blow molding, injection molding, thermoforming, or various form-fill seal technologies. The bottle preferably has a cap that makes it difficult or impossible for a small child to open, and in this aspect can use any conventions cap having such a capability. The bottle also could be made with a conventional cap that does not have a “child-proof” structure. The bottle device of the present invention is not limited to its manufacture by any specific process as it will be understood by those skilled in the art that many different manufacturing techniques can be employed.

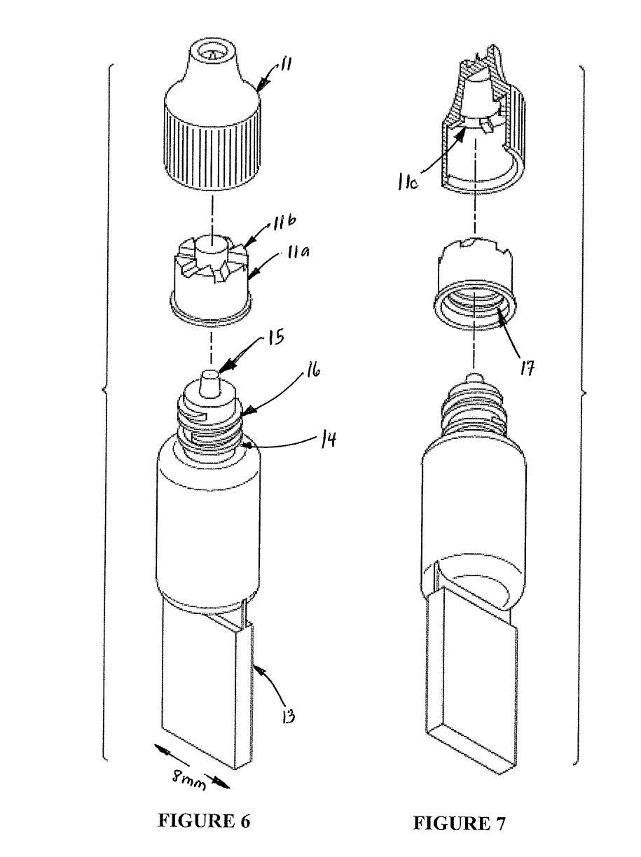

Referring to FIG. 6, the bottle preferably has a cylindrical neck 14 with external threads 16. Referring to FIGS. 6, 7, 8, and 9, the cap 11 has an inner shell 11a with inner threads 17. Threads 17 are engageable with the external threads 16 of the neck 14. Cap 11 fits over the bottle neck and overlies and encloses the inner threaded shell 17 when in a safety or locked position. The inner threaded shell 17 preferably is loosely positioned within the cap 11, and is rotatable within and in relation to the cap 11.

When cap 11 is in a safety or locked position, the cap cannot be opened by mere turning or rotation. To remove the cap, a user must press down on cap 11 and then rotate counter-clockwise (or clockwise, depending on the way in which the neck and shell threads are formed) while pressing down to engage the inner threaded shell 17 with the external threads 16 of the neck 14.

Referring to FIGS. 6, 7, 8, 9, 10 and 11, when the cap 11 is pressed toward the bottle, it interacts with a cogged rim 11b that is present on the upper part of the inner threaded shell 17, referred to herein as inner shell cogged rim 11b. The cogged rim of the inner threaded shell interacts with a corresponding cogged rim on the internal surface of the cap 11, referred to herein as cap cogged rim 11c. Thus, tightening the cap is accomplished by first pressing the cap downward, which causes the cogged rim of the inner threaded shell to engage with the corresponding cogged rim on the internal surface of the cap, and then rotating the cap clockwise.

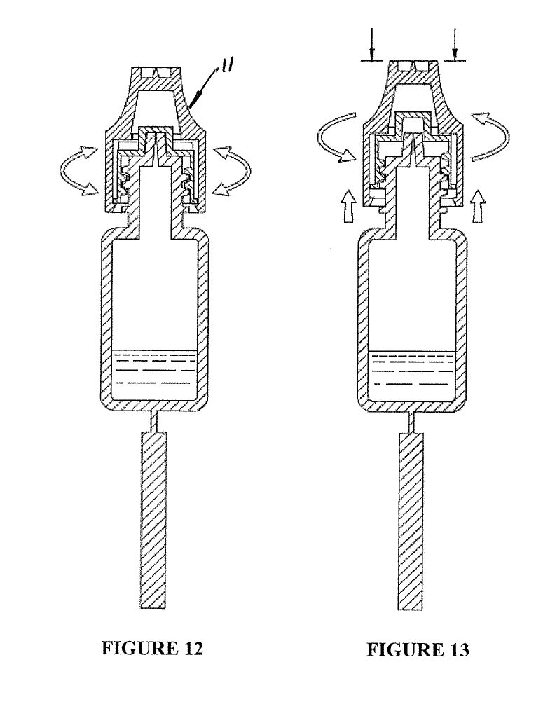

Referring to FIGS. 12 and 13, the cap 11 is removed by initially pressing the cap downward, which causes the cogged rim of the inner threaded shell to engage the corresponding cogged rim on the internal surface of the cap, and then rotating the cap counterclockwise. Without downward pressure on the cap, rotation of the cap causes the cogged rims to slide on each other without engagement. In the presently preferred embodiment, downward pressure on the cap is required to remove the cap from the bottle neck.

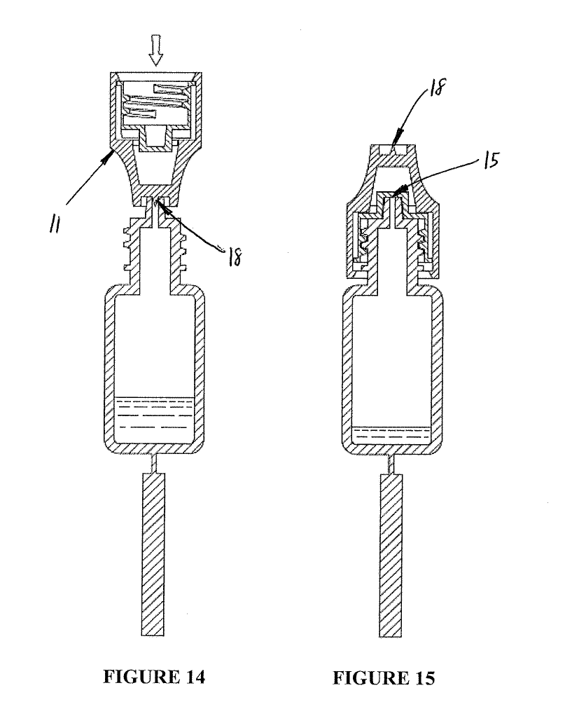

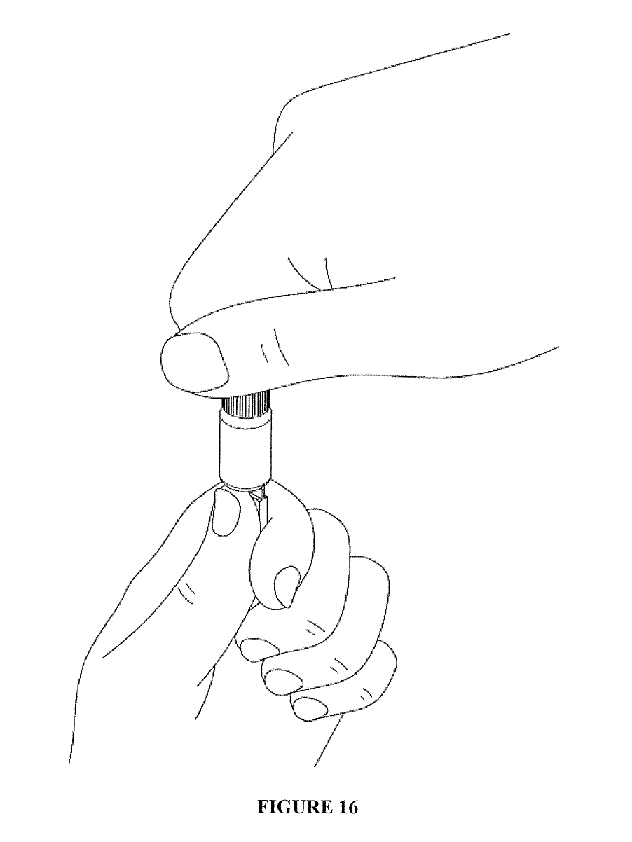

Referring to FIGS. 14 and 15, the distal end of cap includes a cavity 11b that includes a sharp, pointed puncture tool or pin 18 that extends longitudinally from the center. The cavity has an inner diameter such that the inverted cap fits over the tip 15 of the bottle. The pin 18 is adapted for and is intended to be used as a puncture tool for puncturing a thin layer of plastic that seals the opening of the tip.

Referring to FIGS. 6 and 9, the preferred embodiment of the bottle has a body that is cylindrical, has a length of approximately 14 millimeters (mm) from the body's proximal end 20 to the body's distal end 21, and has an outer diameter of approximately 8 mm. The opening 19 can range from 0.2 to 1.0 mm, but is preferably 0.6 to 0.9 mm in diameter. The opening may be sealed or unsealed. If sealed, such as with a thin plastic layer or film, such opening is created by puncturing it using a puncturing tool, such as the sharp protruding portion, or pin, that is located within the cavity portion of the cap. During use the bottle's contents is dispensed through the opening of the extended outlet (nozzle) or tip 15, by squeezing or depressing the body of the bottle such as between two fingers.

The threaded neck 14 has a length of approximately 5 mm, from the extended outlet (nozzle) or tip 15, to the body's distal end 20. The flexible tab 13 has a length of approximately 14 mm from the body's distal end 21, to the tab's distal edge 22. The tab 13 is approximately 8 mm in width and approximately 1.2 mm to 1.5 mm in thickness. This tab is used for ease of handling of the bottle, and can also be used to affix product information such as logos and brand markings, lot number, expiration date, etc.

Liquid can be added to the bottle in several ways, as will be apparent to one skilled in this art. For example, liquid can be added to the bottle prior to thermally sealing the neck.

FIG. 16 shows a user's hands handling the bottle by holding the tab while touching the cap.

The devices, solutions, methods and systems described herein are not limited to the specific embodiments described herein. For example, components of each system and/or steps of each method may be used and/or practiced independently and separately from other components and/or steps described herein. In addition, each component and/or step may also be used and/or practiced with other assemblies and methods.

Although specific embodiments of the invention have been described, various modifications, alterations, alternative constructions, and equivalents are also encompassed within the scope of the invention.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

1. A vaporizable solution nicotine addition kit comprising:
a plurality of nicotine containing solution containers including at least;
a first nicotine containing solution container containing 45 mg of nicotine;
a second nicotine containing solution container containing 90 mg of nicotine;
a third nicotine containing solution container containing 180 mg of nicotine; and,
a fourth nicotine containing solution container containing 360 mg of nicotine;
a plurality of vaporizable solvent containing containers including at least;
a first vaporizable solvent containing container containing 15 ml of vaporizable solvent:
a second vaporizable solvent containing container containing 30 ml of vaporizable solvent;
a third vaporizable solvent containing container containing 60 ml of vaporizable solvent; and,
a fourth vaporizable solvent containing container containing 20 ml of vaporizable solvent;
a third container adapted for mixing all of the contents of a selected one of the plurality of nicotine containing solution containers with all of the contents of a selected one of the plurality of vaporizable solvent containing containers;
a nomogram containing a plurality predetermined, desired concentrations of nicotine in a solution resulting from mixing the contents of one of the plurality of nicotine containing solution containers with the contents of one of the plurality of vaporizable solvent containing containers;
the plurality of predetermined, desired concentrations including at least one of [1.5 mg/ml], [3 mg/ml], [6 mg/ml], [12 mg/ml] and [24 mg/ml] of nicotine; and,
whereby mixing in the third container all of the contents of a selected one of the plurality of nicotine containers with all of the contents of a selected one of the plurality of vaporizable solvent containing containers yields a selected one of the predetermined, desired concentrations of nicotine.

2. The kit of claim 1 wherein the first container has a volume of 1 ml and is sealed.

3. The kit of claim 1 wherein the first container has a volume of 2 ml and is sealed.

4. The kit of claim 1 wherein the vaporizable solvent comprises vegetable glycerin.

5. The kit of claim 1 wherein the vaporizable solvent comprises propylene glycol

6. An e-juice nicotine addition kit comprising:
at least four containers, including a first container, a second container, a third container and a fourth container, each of said four containers having a predetermined container volume, each of said four containers having a predetermined volume of nicotine containing solution, with said first container solution including 45 mg of nicotine, said second container solution including 90 mg of nicotine, said third container solution including 180 mg of nicotine and said fourth container solution including 360 mg of nicotine.

7. The kit component of claim 6 wherein each of the containers has a predetermined container volume of 1 ml.

8. The kit component of claim 6 wherein each of the containers has a predetermined container volume of 2 ml.

9. The kit component of claim 6 wherein each of the containers is sealed.

10. A computer implemented nicotine addition kit for precision addition of nicotine to a nicotine containing, vaporizable solution having a predetermined strength of nicotine comprising:
a plurality of first nicotine solute containers, each said first container having a predetermined volume of nicotine containing solute;
a plurality of second vaporizable solvent containers, each of said second containers having a predetermined volume of vaporizable solvent;
a third container adapted for mixing the contents of a selected one of said first containers with the contents of a selected one of said second containers;
a web-based computer including a memory, an algorithm, a data base, a data input device and a display;
said computer data base including at least data corresponding to a table comprising:
at least one nicotine solute data column representative of said first nicotine solute containers having said predetermined volumes of nicotine containing solutions;
each said nicotine solute data column including a plurality of nicotine solute data rows, each of said nicotine solute data rows including a predetermined amount of nicotine;
a plurality of second, vaporizable solvent data columns, each of said solvent data columns representative of one of said second vaporizable solvent containers and said container's predetermined volume of vaporizable solvent held in said second container;
each of said second, vaporizable solvent columns including a plurality of desired nicotine strengths in a mixed, vaporizable nicotine containing solution resulting from mixing the contents of a selected one of said first containers with the contents of a selected one of said second containers;
said computer and algorithm adapted to calculate and identify the container filled with nicotine solute in the nicotine row in the selected nicotine solute column that corresponds to a selected one of the plurality of desired nicotine strengths and a selected one of the plurality of second vaporizable solvent data columns; and,
whereby mixing in the third container all of the contents of the computer-identified nicotine solute container with all of the contents of the selected one of the second solvent containers a higher concentration nicotine containing solute is mixed with a solvent to yield a lower concentration nicotine solution having said predetermined strength of nicotine.

11. A nicotine addition kit for making a nicotine-containing vaporizable solution having a predetermined amount of nicotine comprising:
at least three nicotine base solute containers, each container having the same total volume of liquid nicotine base, but each of said container containing a different amount of nicotine;
a plurality of solvent containers, each container pre-filled with a specified volume of vaporizable solvent; and,
a nomogram providing a listing of a plurality of final amounts of nicotine and identities of a whole number of nicotine base solute containers and a whole number of solvent containers that, when all of the contents of a selected nicotine base solute container and all of the contents of a corresponding solvent container are mixed, yield said nicotine-containing vaporizable solution having said predetermined amount of nicotine.

12. The system of claim 11 wherein the nicotine base solute containers are sealed tubes.

13. The system of claim 11 wherein the nicotine base solute containers are tamper-resistant bottles having a volume of 2 ml or less.

14. The system of claim 11 wherein each of the nicotine base solute containers e comprise:
a body having a longitudinal axis and a neck extending from one of its ends,
said neck having external threads and a tip with an opening;
a tab extending from the opposite end of said body, and adapted for ease of handling;
a cap that is rotatably engageable with said neck; and,
said bottle is filled with a solution containing nicotine having a predetermined concentration.

15. (canceled)

16. A pre-made e-juice nicotine addition kit comprising:
a plurality of sealed nicotine solute containers containing nicotine solute;
each of said nicotine solute containers containing a predetermined amount of nicotine;
a plurality of sealed e-juice containers containing a non-nicotine containing e-juice;
each of said e-juice containers containing a predetermined volume of vaporizable solution and no nicotine; and,
a nomogram providing a relationship between the plurality of nicotine solute containers and the plurality of non-nicotine containing e-juice containers needed to yield an e-juice having a predetermined amount of nicotine resulting from emptying the contents of a selected one of each and every one of the plurality of nicotine solute containers into a selected one of the plurality of the non-nicotine containing e-juice containers and mixing the nicotine solute with the non-nicotine containing e-juice.

17. The kit of claim 16 wherein the nomogram is a table with at least one column corresponding to one size of the non-nicotine containing nicotine solute containers, each said column including a plurality of rows, each row listing a predetermined amount of nicotine for each size of the nicotine solute containers.

18. The kit of claim 16 wherein the nomogram is a table with a least one column corresponding to one size of the non-nicotine containing e-juice containers, each column including a plurality of rows, each row listing the nicotine amount in the nicotine containing e-juice resulting from mixing the contents of a selected one of the plurality of nicotine containing solute containers with the contents of a selected one of the plurality of non-nicotine containing e-juice containers.

19. A pre-made e-juice nicotine addition kit comprising:
a plurality of sealed nicotine base containers, each said nicotine base container having a predetermined volume of nicotine base;
a plurality of sealed e-juice containers, each said e-juice container having a predetermined volume of e-juice and no nicotine;
a table listing in columns and rows:
said plurality of nicotine base containers;
said plurality of e-juice containers; and,
a plurality of cells,
each cell of said plurality of cells positioned at an intersection of a column and row of a nicotine base and a column and row of an e-juice container; and,
each cell listing a desired amount of nicotine in a nicotine containing e-juice resulting from mixing the predetermined volume of nicotine base of one nicotine base container with the predetermined volume of e-juice in said e-juice container.

20. The kit of claim 19 wherein the plurality of sealed nicotine base containers includes 1 ml containers and 2 ml containers.

21. The kit of claim 19 wherein the plurality of sealed e-juice containers includes at least four differently sized containers.

22. A pre-made e-juice nicotine addition kit comprising:
a plurality of sealed nicotine solute containers containing nicotine solute;
each of said nicotine solute containers containing a predetermined amount of nicotine;
a plurality of sealed e-juice containers containing a nicotine containing e-juice;
each of said nicotine containing e-juice containers containing a predetermined volume of vaporizable solution and a predetermined amount of nicotine; and,
an on-line calculator adapted to provide a relationship between the plurality of nicotine solute containers and the plurality of nicotine containing e-juice containers sufficient to yield a nicotine containing e-juice having a predetermined, relatively higher amount of nicotine resulting from emptying the contents of a selected one of the plurality of nicotine solute containers into a selected one of the plurality of the nicotine containing e-juice containers and mixing the nicotine solute with the nicotine containing e-juice.

23. A pre-made e-juice nicotine addition kit comprising:
a plurality of sealed nicotine solute containers containing nicotine solute;
said plurality of solute containers including at least two different sizes of containers, each of the different sizes of containers containing at least two different amounts of nicotine solute;
a plurality of sealed e-juice containers containing a non-nicotine containing e-juice;
each of said e-juice containers containing a predetermined volume of vaporizable solution and no nicotine; and,
a calculator providing a relationship between the plurality of nicotine solute containers, the plurality of non-nicotine containing e-juice containers and an e-juice having a predetermined amount of nicotine resulting from mixing the entire contents of one of said nicotine solute containers with the contents of a chosen one of said vaporizable solution containers;
whereby mixing the entire contents of said one nicotine solute container with the contents of said chosen one of said vaporizable solution containers yields said e-juice having said predetermined amount of nicotine.
